(19) United States
(12) Patent Application Publication
(10) Pub. No.: US 2025/0007682 A1
(43) Pub. Date: Jan. 2, 2025

(54) INFORMATION PROCESSING SYSTEM, INFORMATION SYNCHRONIZATION SYSTEM, AND NON-TRANSITORY COMPUTER READABLE MEDIUM

(71) Applicant: FUJIFILM Business Innovation Corp., Tokyo (JP)

(72) Inventor: Masaru FUJII, Kanagawa (JP)

(73) Assignee: FUJIFILM Business Innovation Corp., Tokyo (JP)

(21) Appl. No.: 18/521,322

(22) Filed: Nov. 28, 2023

(30) Foreign Application Priority Data
Jun. 27, 2023 (JP) 2023-105274

(51) Int. Cl. H04L 7/00

(52) U.S. Cl. CPC H04L 7/0008

(57) ABSTRACT

An information processing system includes a processor configured to: perform standard synchronization that synchronizes information between the information processing system and a synchronization destination by communicating with the synchronization destination at predetermined time intervals; and if the information processing system becomes unable to communicate with the synchronization destination in a communication disabled state, transmit, to one of the other information processing systems performing the standard synchronization, an execution instruction that causes the one information processing system to perform proxy synchronization to operate as a proxy for synchronization of the information between the information processing system and the synchronization destination.

### Cross-Reference to Related Applications

This application is based on and claims priority under 35 USC 119 from Japanese Patent Application No. 2023-105274 filed Jun. 27, 2023.

### Background

### (i) Technical Field

The present disclosure relates to an information processing system, an information synchronization system, and a non-transitory computer readable medium.

### (ii) Related Art

Japanese Unexamined Patent Application Publication No. 2020-144763 discloses a system including multiple client terminals and a receiving service system receiving data from the client terminals. The receiving service system includes a first receiving unit that receives, from the client terminals, data serving as a target of a specific operation and a second receiving unit that receives, from a specific one of the client terminals, data not serving as the target of the specific operation. Each of the client terminals includes a storage unit that stores a first transmission rule indicating that data is transmitted to the first receiving unit and a first transmitting unit that transmits data from the client terminal to the first receiving unit. The storage unit stores a second transmission rule indicating that data is transmitted to the second receiving unit if an amount of data transmitted from the client terminal to the first receiving unit per unit time is determined to exceed a predetermined value. In accordance with the second transmission rule, the first transmitting unit transmits, to the second receiving unit, data about an event that has occurred on the client terminal.

Japanese Patent No. 7071665 discloses a printer that causes another printer to perform proxy communication in which the other printer performs communications that are repeated with an information processing apparatus. The printer includes a receiving unit and a controller. The receiving unit receives an operation of a user. When the other printer is caused to perform the proxy communication, the receiving unit may receive a specific operation that is an operation used to request the information processing apparatus to perform a specific operation. In response, the controller performs control to request the information processing apparatus to perform the specific operation and also performs control to cause the other printer performing the proxy communication to transmit information used to cancel the proxy communication.

If an information processing system performs only standard communication that synchronizes information with a synchronization destination by communicating with the synchronization destination at predetermined time intervals and when the information processing system becomes unable to communicate with the synchronization destination in a communication disabled state, it may be difficult to synchronize information between the information processing system and the synchronization destination.

### SUMMARY

Aspects of non-limiting embodiments of the present disclosure relate to synchronizing information between an information processing system and a synchronization destination if the information processing system becomes unable to communication the synchronization destination in a communication disabled state.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: perform standard synchronization that synchronizes information between the information processing system and a synchronization destination by communicating with the synchronization destination at predetermined time intervals; and if the information processing system becomes unable to communicate with the synchronization destination in a communication disabled state, transmit, to one of the other information processing systems performing the standard synchronization, an execution instruction that causes the one information processing system to perform proxy synchronization to operate as a proxy for synchronization of the information between the information processing system and the synchronization destination.

### BRIEF DESCRIPTION OF THE DRAWINGS

Exemplary embodiment of the present disclosure will be described in detail based on the following figures, wherein:

FIG. 1 illustrates an information synchronization system of the exemplary embodiment;

FIG. 2 is a block diagram illustrating an example of a hardware configuration of a first multi-function apparatus of the exemplary embodiment;

FIG. 3 is a functional block diagram illustrating a controller of the first multi-function apparatus of the exemplary embodiment;

FIG. 4 is a block diagram illustrating an example of a hardware configuration of a second multi-function apparatus of the exemplary embodiment;

FIG. 5 is a functional block diagram illustrating the second multi-function apparatus of the exemplary embodiment;

FIG. 6 is a flowchart illustrating a flow example of an information synchronization process of the exemplary embodiment;

FIG. 7 is a flowchart illustrating a flow example of a first process of the exemplary embodiment; and

FIG. 8 is a flowchart illustrating a flow example of a second process of the exemplary embodiment.

### DETAILED DESCRIPTION

Exemplary embodiment of the disclosure is described with reference to the drawings. Information Synchronization System 10

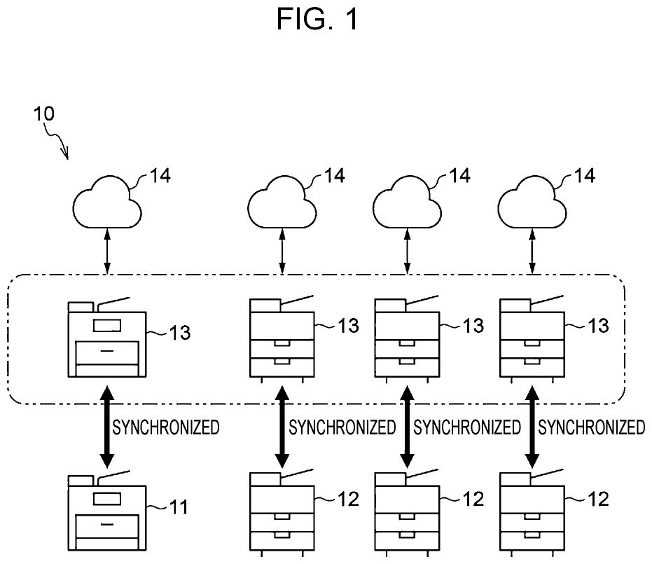

Information synchronization system 10 of the exemplary embodiment is described first. FIG. 1 illustrates the information synchronization system 10 of the exemplary embodiment.

The information synchronization system 10 performs information processing including an information synchronization process as a predetermined process. Referring to FIG. 1, the information synchronization system 10 includes a first multi-function apparatus 11, second multi-function apparatus 12, cloud 14, and multiple virtual devices 13

Specifically, the information synchronization system 10 includes multiple (specifically, three or more) multi-function apparatuses (specifically, the first multi-function apparatus 11 and second multi-function apparatus 12), cloud 14, and multiple virtual device 13 (specifically, of the number equal to the number of multi-function apparatuses). The first multi-function apparatus 11, second multi-function apparatuses 12, and cloud 14 (the virtual devices 13) are communicably interconnected to each other via a network. Elements of the information synchronization system are is described below.

### First Multi-function Apparatus 11

The first multi-function apparatus 11 is an example of an information processing system processing information and also an example of a first information processing system. The first multi-function apparatus 11 may also be referred to as an information processing apparatus.

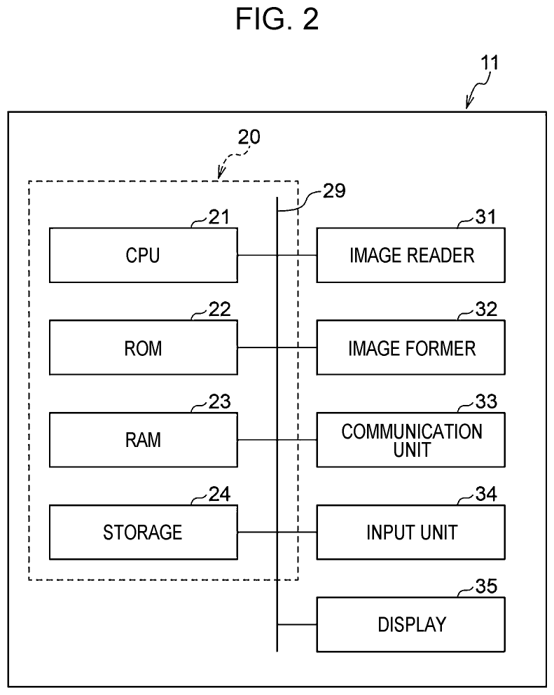

The first multi-function apparatus 11 is an apparatus that performs a copying operation, printing operation, scanning operation, and fax operation. Specifically, as illustrated in FIG. 2, the first multi-function apparatus 11 includes a controller 20, image reader 31, image former 32, communication unit 33, input unit 34, and display 35.

The image reader 31 is a unit (such as a scanner) that reads an image of an original document. The image reader 31 generates image data by optically reading the image of the original document and converting the image into a digital signal. The image includes characters.

The image former 32 forms an image on a recording medium, such as a paper sheet. The image former 32 forms the image on the recording medium through an electrophotographic system that performs charging, exposure, development, transfer, and fixing operations. Alternatively, the image former 32 may generate the image on the recording medium through another system, such as an ink-jet system.

The communication unit 33 communicates with other apparatuses, including the second multi-function apparatuses 12 and cloud 14 (virtual device 13). Specifically, the communication unit 33 communicates with the other apparatuses through communication media, such as wired network, wireless network, the Internet, intranet, and/or public network, such as telephone network. The communication media may be based on voice, light, vibration, and/or image.

According to the exemplary embodiment, the communication unit 33 communicates with the cloud 14 (the virtual device 13) and the second multi-function apparatuses 12 using different networks. For example, the communication unit 33 communicates with the cloud 14 (the virtual device 13) using a network (such as the Internet) to which any terminal has access.

The communication unit 33 communicates with the second multi-function apparatus 12 using the network 19 to which a particular terminal has access (such as dedicated network like Internet Protocol Virtual Network (IP-VPN) and WiFi (registered trademark) tethering based on wireless local area network (LAN)).

Since the communication unit 33 communicates with the cloud 14 (the virtual device 13) and the second multi-function apparatuses 12 using different networks, there are times when the communication unit 33 is able to communicate with the second multi-function apparatuses 12 while being unable to communicate with the cloud 14 (the virtual device 13).

The first multi-function apparatus 11 performs a scanning operation when the image reader 31 reads an image of a document and generates image data. The first multi-function apparatus 11 performs the fax operation by transmitting to another apparatus, such as another multi-function apparatus, the image data that the image reader 31 generates by reading the image of the document.

The first multi-function apparatus 11 performs the copying operation when the image former 32 forms an image onto a recording medium in response to the image data that the image reader 31 has generated by reading the image of the document. The first multi-function apparatus 11 performs the printing operation when the image former 32 forms the image onto the recording medium, such as a paper sheet, in response to the image data retrieved from a terminal, such as a personal computer or a smart phone, or a memory, such as a universal serial bus (USB) memory.

The input unit 34 receives an instruction from a user. Specifically, the input unit 34 includes input keys (such as a keyboard or operation buttons) and touch panel, operated by the user.

The instructions provided by the user may include an execution instruction instructing the first multi-function apparatus 11 to carry out a job for each of the copying, printing, scanning, and/or fax operations. The job refers to a process unit that is executed in response to one instruction from the user.

The display 35 is an example of a notifier and notifies the user of presentation information by displaying the presentation information to the user. For example, the display 35 is a liquid-crystal display or an electroluminescence (EL) display.

The display 35 may operate as the input unit 34. In such a case, the input unit 34 is a resistive touch panel or an electrostatic capacitance touch panel and receives an instruction from the user in response to a touch operation of the user.

The controller 20 controls the elements of the first multi-function apparatus 11. The controller 20 has a function working as a computer and includes, as illustrated in FIG. 2, a central processing unit (CPU) 21, read-only memory (ROM) 22, random-access memory (RAM) 23, and storage 24. The CPU 21, ROM 22, RAM 23, and storage 24 are interconnected to each other via a bus 29.

The CPU 21 executes a variety of programs including an information synchronization program and an information processing program and controls the elements of the first multi-function apparatus 11. The ROM 22 stores a variety of programs including the information processing program and data. The RAM 23 operates as a working area and temporarily stores the programs and data. The storage 24 is a hard disk drive (HDD), solid-state drive (SSD), or flash memory, and stores a variety of programs including an operating system and a variety of data (for example, list information of destinations of the second multi-function apparatus 12). The information processing program may be stored on the storage 24.

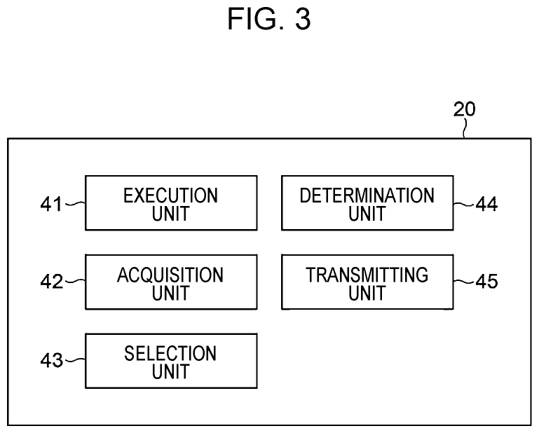

The CPU 21 in the controller 20 retrieves the variety of programs including the information processing program from the ROM 22 or storage 24 and executes the read program using the RAM 23 as the working area. The CPU 21 implements a variety of functions that control the elements of the first multi-function apparatus 11 by executing the information processing program. As described below, a functional configuration of the controller 20 is implemented when the CPU 21 serving as a hardware resource and the information processing program serving as a software resource cooperate with each other. FIG. 3 is a block diagram illustrating the functional configuration of the controller 20 of the exemplary embodiment.

As illustrated in FIG. 3, the controller 20 operates as an execution unit 41, acquisition unit 42, selection unit 43, determination unit 44, and transmitting unit 45 when the CPU 21 executes the information processing program.

The execution unit 41 communicates with the virtual device 13 at predetermined time intervals and performs a synchronization operation (hereinafter referred to as standard synchronization) in which information is synchronized between the first multi-function apparatus 11 and the virtual device 13. Specifically, the execution unit 41 performs the standard synchronization by communicating with the virtual device 13 at fixed time intervals (namely, periodically).

The synchronization refers to an operation that causes information stored on the first multi-function apparatus 11 to match information stored on the virtual device 13. According to the exemplary embodiment, a variety of information stored on the first multi-function apparatus 11 (such as parameter information) is also stored on the virtual device 13 and the information stored on the virtual device 13 is updated such that a difference between the information on the first multi-function apparatus 11 and the information on the virtual device 13 is eliminated. Alternatively, the information stored on the first multi-function apparatus 11 may be updated such that the difference between the information stored on the first multi-function apparatus 11 and the information stored on the virtual device 13 is eliminated.

The acquisition unit 42 acquires, from the second multi-function apparatuses 12, information (hereinafter referred to as first selection information) as selection criteria according to which an execution apparatus that performs a proxy operation (hereinafter referred to as proxy synchronization) is selected as a proxy to perform information synchronization between the first multi-function apparatus 11 and the virtual device 13. The execution apparatus is an example of an execution system.

The first selection information is information (hereinafter referred to as execution information) that indicates whether the second multi-function apparatus 12 performs the proxy synchronization for another second multi-function apparatus 12. The other second multi-function apparatus 12 is an example of an information processing system different from the first multi-function apparatus 11.

The selection unit 43 selects an execution apparatus from the second multi-function apparatuses 12 according to the first selection information acquired by the acquisition unit 42. Specifically, the second multi-function apparatus 12 performing the proxy synchronization of the other second multi-function apparatus 12 is selected according to the execution information acquired by the acquisition unit 42.

The determination unit 44 determines whether the first multi-function apparatus 11 is enabled to communicate with the virtual device 13 (this state is hereinafter referred to a communication enabled state) or not enabled to communicate with the virtual device 13 (this state is hereinafter referred to as a communication disabled state). For example, if the determination unit 44 attempts to communicate with the virtual device 13 several times at predetermined time intervals but a timeout occurs after a predetermined period of time, the determination unit 44 determines that the first multi-function apparatus 11 is in the communication disabled state.

If the determination unit 44 determines that the first multi-function apparatus 11 is in the communication disabled state, the transmitting unit 45 transmits, to the second multi-function apparatus 12 selected by the selection unit 43, an execution instruction to perform the proxy synchronization.

The first selection information acquired by the acquisition unit 42 may include information (hereinafter referred to as communication information) indicating whether the second multi-function apparatus 12 is communicable with the virtual device 13. In accordance with the communication information acquired by the acquisition unit 42, the selection unit 43 may select as the execution apparatus the second multi-function apparatus 12 communicable with the virtual device 13.

The first selection information acquired by the acquisition unit 42 may include the communication information and information (hereinafter referred to as load information) indicating a synchronization load when information is synchronized between the second multi-function apparatus 12 and the virtual device 13. In accordance with the communication information and load information, acquired by the acquisition unit 42, the selection unit 43 may select as the execution apparatus a second multi-function apparatus 12 that is communicable with the virtual device 13 and has a minimum synchronization load.

When the second multi-function apparatus 12 performs the proxy synchronization, the load information indicates a load and an addition of cost involving a process of the second multi-function apparatus 12. Specifically, the load information is information related to a load average, memory usage, throughput of a communication adaptor, additional charge amount in communication fee for the proxy synchronization, and number of users as operators.

The acquisition unit 42 may be enabled to acquire information (hereinafter referred to as disability information) indicating that the second multi-function apparatus 12 having performed perform the proxy synchronization is in the communication disabled state. If the acquisition unit 42 acquires the disability information, the transmitting unit 45 may transmit the execution instruction to another different second multi-function apparatus 12 different from the second multi-function apparatus 12 having performed the proxy synchronization.

The acquisition unit 42 may further acquire, from the different second multi-function apparatuses 12, information serving as selection criteria (hereinafter referred to as second selection information) according to which an execution apparatus caused to perform the proxy synchronization is selected from the different second multi-function apparatuses 12. In this case, the selection unit 43 selects the execution apparatus from the different second multi-function apparatuses 12 in accordance with the second selection information acquired by the acquisition unit 42 and the transmitting unit 45 transmits the execution instruction to perform the proxy synchronization to the different second multi-function apparatus 12 selected by the selection unit 43.

The second selection information is similar to the first selection information and specifically includes information indicating whether the different second multi-function apparatus 12 performs the proxy synchronization for another second multi-function apparatus 12. The second selection information may further include information indicating that the other second multi-function apparatus 12 is communicable with the virtual device 13 and information indicating the synchronization load when the other second multi-function apparatus 12 synchronizes information on the virtual device 13.

If the determination unit 44 determines that the first multi-function apparatus 11 has shifted from the communication disabled state to the communication enabled state, the transmitting unit 45 transmits to the second multi-function apparatus 12 an instruction to end the execution of the proxy synchronization (hereinafter referred to as end instruction). In this case, when the second multi-function apparatus 12 ends the execution of the proxy synchronization, the execution unit 41 resumes the standard synchronization.

### Second Multi-function Apparatus 12

The second multi-function apparatus 12 is an example of another information processing system processing information and also an example of a second information processing system. The second multi-function apparatus 12 may also referred to as an information processing apparatus processing information. If the second multi-function apparatus 12 performing the proxy synchronization is another information processing system performing the proxy synchronization, a second multi-function apparatus 12 other than the second multi-function apparatus 12 performing the proxy synchronization is an example of the different second multi-function apparatus 12.

The second multi-function apparatus 12 is identically configured to the first multi-function apparatus 11 and capable of performing the copying, printing, scanning, fax and other operations. The following discussion focuses on a difference between the first multi-function apparatus 11 and the second multi-function apparatus 12 and the discussion of the same portions are appropriately omitted herein.

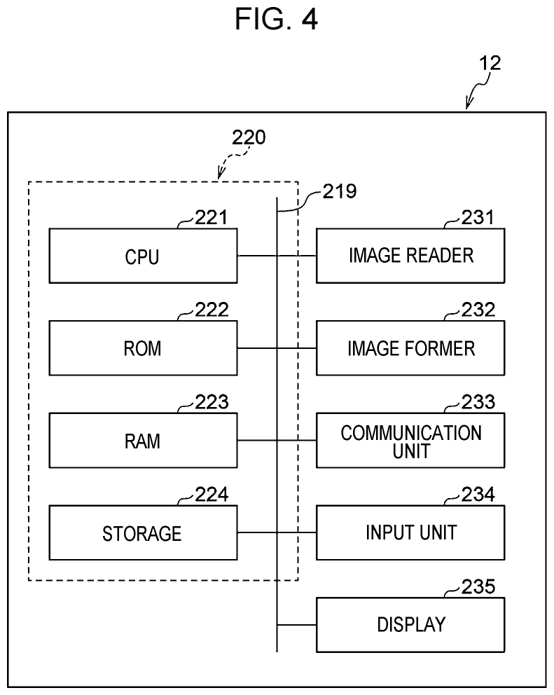

Referring to FIG. 4, the second multi-function apparatus 12 includes a controller 220, image reader 231, image former 232, communication unit 233, input unit 234, and display 235.

The controller 220 has functions as a computer and includes, as illustrated in FIG. 4, a CPU 221, ROM 222, RAM 223, and storage 224. The CPU 221, ROM 222, RAM 223, and storage 224 are connected to each other via a bus 219.

The controller 220, image reader 231, image former 232, communication unit 233, input unit 234, display 235, CPU 221, ROM 222, RAM 223, storage 224, and bus 219 in the second multi-function apparatus 12 are respectively identically configured to the controller 20, image reader 31, image former 32, communication unit 33, input unit 34, display 35, CPU 21, ROM 22, RAM 23, storage 24, and bus 29 in the first multi-function apparatus 11.

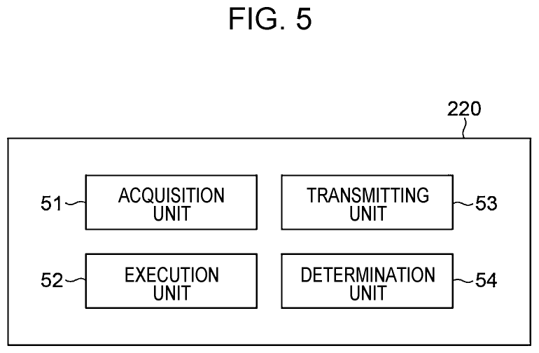

The CPU 221 in the controller 220 operates as an acquisition unit 51, execution unit 52, transmitting unit 53, and determination unit 54 as illustrated in FIG. 5 by executing the information processing program.

The acquisition unit 51 acquires from the first multi-function apparatus 11 an execution instruction to perform the proxy synchronization. The acquisition unit 51 also acquires from the first multi-function apparatus 11 a transmission instruction to transmit the selection information. When the acquisition unit 51 receives the execution instruction, the execution unit 52 executes the proxy synchronization.

When the acquisition unit 51 receives the transmission instruction, the transmitting unit 53 transmits to the first multi-function apparatus 11 the selection information on the second multi-function apparatus 12 (specifically, the first selection information and second selection information). When the proxy synchronization is completed, the transmitting unit 53 transmits to the first multi-function apparatus 11 an end notification notifying of the end of the proxy synchronization.

The determination unit 54 determines whether the second multi-function apparatus 12 is unable to communicate with the virtual device 13 in the communication disabled state. If the determination unit 54 determines that the second multi-function apparatus 12 is in the communication disabled state, the execution unit 52 ends the execution of the proxy synchronization.

### Cloud 14 and Virtual Device 13

As previously described, the cloud 14 is capable of communicating with the first multi-function apparatus 11 and the second multi-function apparatus 12 and provides a variety of services. For example, the cloud 14 is a management server that manages the information synchronization system 10.

The virtual device 13 is an example of a synchronization destination. The virtual device 13 is a device that is virtually constructed over the cloud 14. The virtual device 13 is communicable with and is thus able to exchange information with the first multi-function apparatus 11 and second multi-function apparatus 12. Specifically, the virtual device 13 is constructed as a digital twin of each of the first multi-function apparatus 11 and second multi-function apparatus 12 and synchronizes information with the first multi-function apparatus 11 and second multi-function apparatus 12.

### Proxy Synchronization Process of Information Synchronization System 10

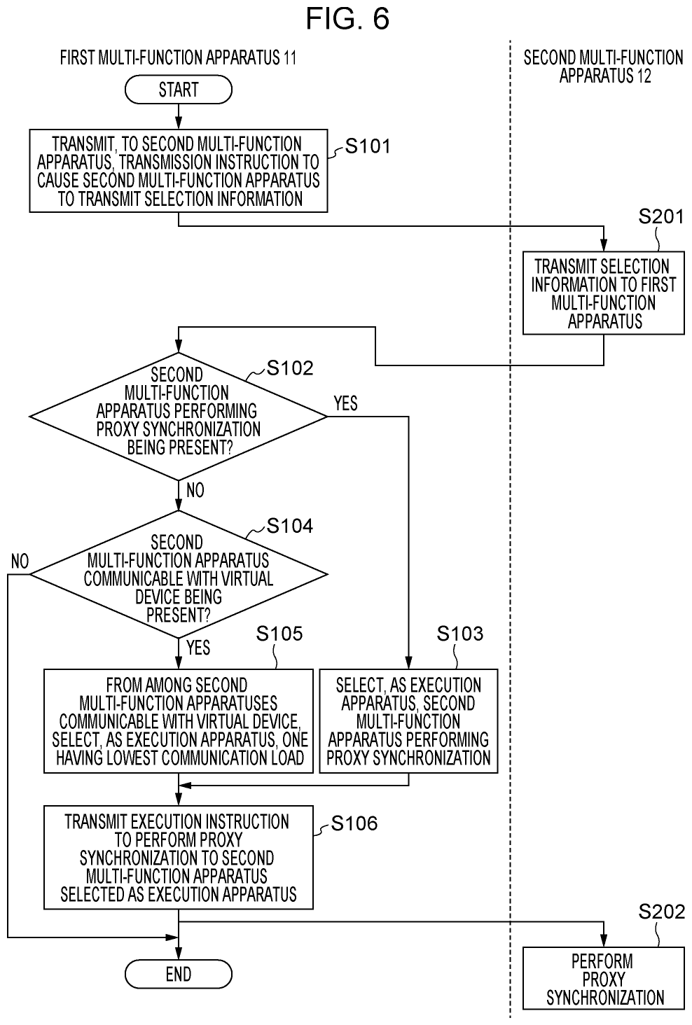

Proxy synchronization process performed by the information synchronization system 10 is described below. FIG. 6 is a flowchart illustrating a flow of the information synchronization process of the exemplary embodiment.

In the information synchronization system 10, the CPU 21 in the first multi-function apparatus 11 determines whether the communication unit 33 is communicable with the virtual device 13 and if the CPU 21 determines that the communication unit 33 is not communicable with the virtual device 13, the proxy synchronization process is performed.

The proxy synchronization process is performed in the exemplary embodiment when the CPU 21 in the first multi-function apparatus 11 and the CPU 221 in the second multi-function apparatus 12 cooperate with each other with the CPU 21 reading an information synchronization program from the ROM 22 or storage 24 and the CPU 221 reading an information synchronization program from the ROM 222 or storage 224.

Referring to FIG. 6, the CPU 21 starts the proxy synchronization process, references list information on the second multi-function apparatuses 12 as destinations, and then transmits to multiple second multi-function apparatuses 12 the transmission instruction causing the second multi-function apparatuses 12 to transmit the selection information (step S101).

The list information on the second multi-function apparatuses 12 as the destinations is stored on a storage of the cloud 14 or an in-house server, each serving as a storage destination. The list information is automatically updated when the list information is edited by the administrator or when the list information is referenced by a management system managing a variety of information on the second multi-function apparatuses 12. The CPU 21 periodically references and acquires the list information on the storage destination and then stores the list information on the storage 24 or the like. If the first multi-function apparatus 11 is unable to communicate due to a communication failure, the list information stored on the storage 24 or the like may be still referenced. Specifically, if a communication failure occurs in the proxy synchronization process, the list information on the storage destination is difficult to refer to.

After the transmission instruction causing the second multi-function apparatus 12 to transmit the selection information is transmitted to the second multi-function apparatuses 12 (step S101), the CPU 221 in the second multi-function apparatus 12 transmits the selection information on the second multi-function apparatus 12 to the communication unit 33 in the first multi-function apparatus 11 (step S201). The selection information serves as selection criteria according to which a multi-function apparatus (execution apparatus) caused to perform the proxy synchronization is selected. The selection information includes the execution information indicating whether the second multi-function apparatus 12 performs the proxy synchronization for another second multi-function apparatus 12, the communication information indicating whether the second multi-function apparatus 12 is communicable with the virtual device 13, and the load information indicating a synchronization load when the second multi-function apparatus 12 is synchronized with the information on the virtual device 13.

When the second multi-function apparatus 12 performs the proxy synchronization, the load information indicates a load and an addition of cost involving a process of the second multi-function apparatus 12. Specifically, the load information is information related to the load average, memory usage, throughput of the communication adaptor, additional charge amount in communication fee for the proxy synchronization, and the number of users as the operators.

The CPU 21 acquires the selection information and determines whether a second multi-function apparatus 12 performing the proxy synchronization is present (step S102).

If the CPU 21 determines that a second multi-function apparatus 12 performing the proxy synchronization is present (yes path in $102), the CPU 21 selects the second multi-function apparatus 12 as an execution apparatus performing the proxy synchronization (step S103) and then proceeds to step S106.

If a second multi-function apparatus 12 performing the proxy synchronization is not present (no path in step S102), the CPU 21 determines whether a second multi-function apparatus 12 communicable with the virtual device 13 is present (step S104).

If the CPU 21 determines that a second multi-function apparatus 12 communicable with the virtual device 13 is present (yes path in S104), the CPU 21 selects, from among the second multi-function apparatuses 12 communicable with the virtual device 13, a second multi-function apparatus 12 having a minimum value when being synchronized with the information on the virtual device 13 (step S105) and then proceeds to step S106. For example, in step S105, the CPU 21 selects a load score of each of the second multi-function apparatuses 12 and selects the second multi-function apparatus 12 having the smallest load score.

On the other hand, if the CPU 21 determines that there is no second multi-function apparatus 12 communicable with the virtual device 13 (no path in step S104), the CPU 21 ends the proxy synchronization process.

In step $106, the CPU 21 transmits to the second multi-function apparatus 12 selected as the execution apparatus the execution instruction causing the selected second multi-function apparatus 12 to perform the proxy synchronization and then ends the proxy synchronization process. In this way, the CPU 21 acquires the execution instruction and performs the proxy synchronization (step S202).

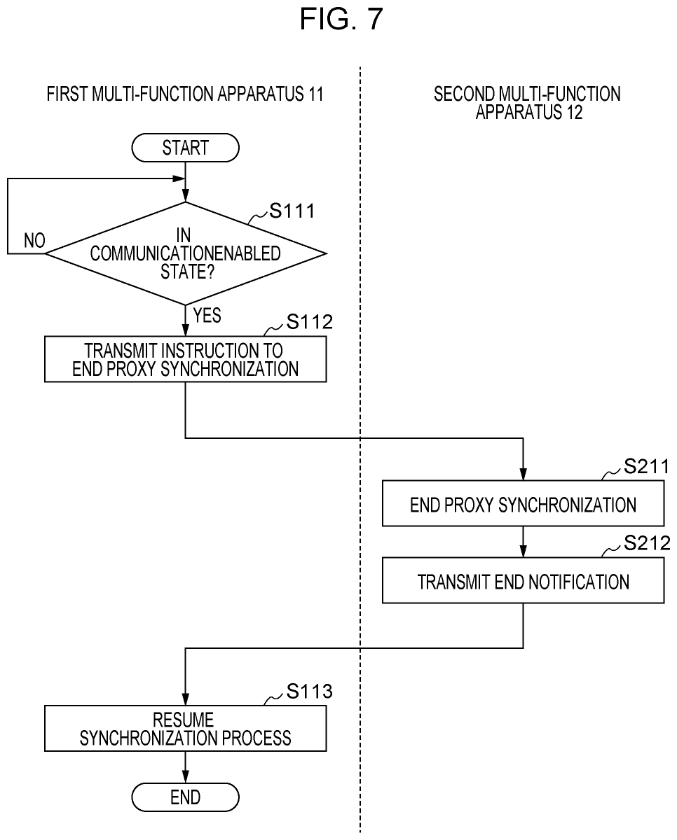

The CPU 21 performs a first process (see FIG. 7) described below the second multi-function apparatus 12 performs the proxy synchronization. Specifically, the CPU 21 transmits the execution instruction to cause the second multi-function apparatus 12 selected as the execution apparatus to perform the proxy synchronization (step S106 (see FIG. 6)) and starts the first process.

As illustrated in FIG. 7, the CPU 21 determines in the first process whether the first multi-function apparatus 11 is communicable with the virtual device 13 in the communication enabled state (step S111).

If the CPU 21 determines that the first multi-function apparatus 11 is not communicable with the virtual device 13 (no path in step S111), the CPU 21 iterates step S111 until the first multi-function apparatus 11 is determined to be communicable with the virtual device 13. If the second multi-function apparatus 12 completes the proxy synchronization during the operation in step S111 (if the end notification indicating the end of the proxy synchronization is received from the second multi-function apparatus 12), the first multi-function apparatus 11 ends the first process.

If the first multi-function apparatus 11 is determined to be communicable with the virtual device 13 (yes path in S111), the CPU 21 transmits to the second multi-function apparatus 12 an end instruction to end the proxy synchronization (step S112).

The CPU 221 in the second multi-function apparatus 12 thus completes the execution of the proxy synchronization (step S211) and transmits to the first multi-function apparatus 11 an end notification indicating the end of the proxy synchronization (step S212).

In response to the reception of the end notification from the second multi-function apparatus 12, the CPU 21 resumes the proxy synchronization for the first multi-function apparatus 11 to communicate with and synchronize with the virtual device 13 (step S113) and ends the first process.

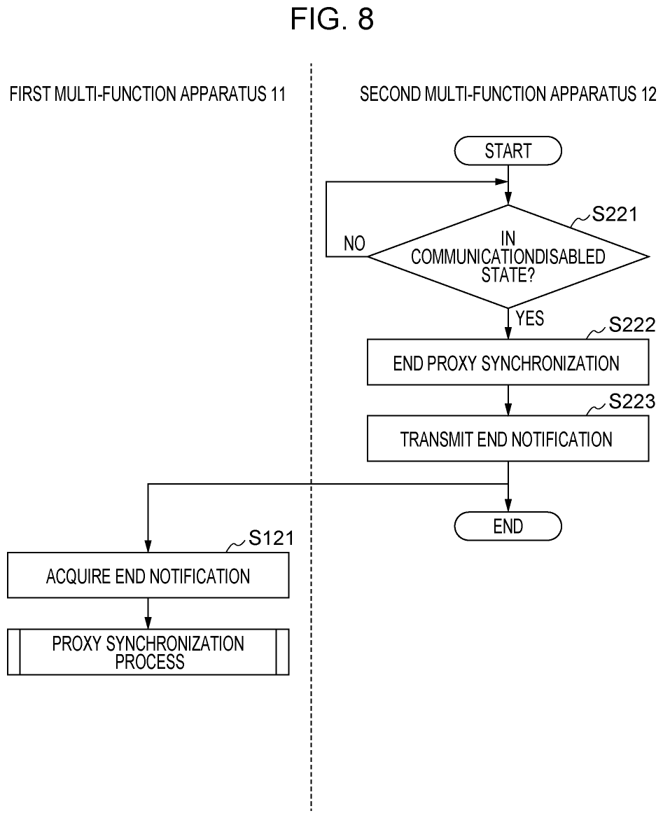

The CPU 221 performs a second process (see FIG. 8) as described below when the second multi-function apparatus 12 performs the proxy synchronization. Specifically, the CPU 221 performs the second process when the second multi-function apparatus 12 performs the proxy synchronization (step S202 (see FIG. 6)).

The CPU 221 determines in the second process whether the second multi-function apparatus 12 is not communicable with the virtual device 13 in the communication disabled state as illustrated in FIG. 8 (step S221).

If the CPU 221 determines that the second multi-function apparatus 12 is not in the communication disabled state with the virtual device 13 (no path in step S221), the CPU 221 iterates the operation in step S221 until the second multi-function apparatus 12 is in the communication disabled state.

If the CPU 221 determines that the second multi-function apparatus 12 is in the communication disabled state with the virtual device 13 (yes path in S221), the CPU 221 ends the execution of the proxy synchronization (step S222) and transmits to the first multi-function apparatus 11 the end notification indicating the end of the proxy synchronization (step S223).

In response to the reception of the end notification from the second multi-function apparatus 12 (step S121), the CPU 21 ends the second process and starts performing the proxy synchronization process again (see FIG. 6).

The CPU 21 performs the proxy synchronization (see FIG. 6) again, thereby transmitting the execution instruction to another different second multi-function apparatus 12 different from the second multi-function apparatus 12 having performed the proxy synchronization.

Specifically, the CPU 21 acquires, from the different second multi-function apparatuses 12, the second selection information serving as criteria according to which the execution apparatus to be caused to perform the proxy synchronization is selected from the different second multi-function apparatuses 12, selects the execution apparatus from the different second multi-function apparatuses 12 in accordance with the acquired second selection information (steps S101 through S105 (see FIG. 6)), and then transmits to the selected different second multi-function apparatus 12 the execution instruction to cause the proxy synchronization to be performed (step $106 (see FIG. 6)).

Operations of Exemplary Embodiment

If the first multi-function apparatus 11 shifts to the communication disabled state in the exemplary embodiment, the CPU 21 transmits to the second multi-function apparatus 12 the execution instruction to perform the proxy synchronization (step S106 (see FIG. 6)).

Even if the first multi-function apparatus 11 is in the communication disabled state, information may thus be synchronized between the first multi-function apparatus 11 and the virtual device 13.

Specifically, when the first multi-function apparatus 11 is in the communication disabled state in the exemplary embodiment, the CPU 21 selects, from among the second multi-function apparatuses 12, the execution apparatus that is to perform the proxy synchronization (steps S102 through S105 (see FIG. 6)) and transmits the execution instruction to the second multi-function apparatus 12 selected as the execution apparatus (step S106 (scc FIG. 6)).

In this way, an appropriate second multi-function apparatus 12 serving as the execution apparatus may thus perform the proxy synchronization.

More specifically, the CPU 21 selects the second multi-function apparatus 12 performing the proxy synchronization for another second multi-function apparatus 12 in the exemplary embodiment (step S103 (see FIG. 6)) and transmits the execution instruction to the selected second multi-function apparatus 12 (step S106 (scc FIG. 6)).

The second multi-function apparatus 12 performing the proxy synchronization for another second multi-function apparatus 12 (in other words, the second multi-function apparatus 12 recognized as being eligible to perform the proxy synchronization) may thus perform the proxy synchronization.

According to the exemplary embodiment, if a second multi-function apparatuses 12 performing the proxy synchronization is not present, the CPU 21 selects a second multi-function apparatus 12 that is communicable with the virtual device 13 and has the lowest synchronization load (step S105 (see FIG. 6)) and transmits the execution instruction to the selected second multi-function apparatus 12 (step S106 (see FIG. 6)).

The second multi-function apparatus 12 communicable with the virtual device 13 (in other words, the second multi-function apparatus 12 capable of performing the proxy synchronization and having a minimum effect caused by the proxy synchronization) may thus perform the proxy synchronization.

If the disability information indicating that the second multi-function apparatus 12 having performed the proxy synchronization has shifted to the communication disabled state is received in the exemplary embodiment (step S121 (see FIG. 8)), the CPU 21 transmits the execution instruction to the different second multi-function apparatus 12 different from the second multi-function apparatus 12 having performed the proxy synchronization.

Even when the second multi-function apparatus 12 having performed the proxy synchronization has shifted to the communication disabled state, information may be synchronized between the first multi-function apparatus 11 and the virtual device 13.

Specifically, if the disability information indicating that the second multi-function apparatus 12 having performed the proxy synchronization has shifted to the communication disabled state is acquired, the execution instruction may be transmitted to another different second multi-function apparatus 12 selected as the execution apparatus performing the proxy synchronization.

Even when the second multi-function apparatus 12 having performed the proxy synchronization is not communicable with the virtual device 13, an appropriate different second multi-function apparatus 12 serving as the execution apparatus may perform the proxy synchronization.

According to the exemplary embodiment, if the first multi-function apparatus 11 has shifted from the communication disabled state to the communication enabled state (yes path in S111 (see FIG. 7)), the CPU 21 transmits to the second multi-function apparatus 12 the end instruction to end the execution of the proxy synchronization (step S112 (see FIG. 7)).

With the first multi-function apparatus 11 shifting from the communication disabled state to the communication enabled state, the synchronization load on the second multi-function apparatus 12 may thus be lower than when the second multi-function apparatus 12 is caused to continue the proxy synchronization.

According to the exemplary embodiment, when the second multi-function apparatus 12 ends the proxy synchronization, the CPU 21 resumes the execution of the standard synchronization (step S113 (see FIG. 7)).

The CPU 21 thus restricts a parallel operation of the standard synchronization and proxy synchronization unlike when the standard synchronization resumes before the second multi-function apparatus 12 ends the proxy synchronization. Modifications

According to the exemplary embodiment, the multi-function apparatuses (specifically, the first multi-function apparatus 11 and the second multi-function apparatus 12) are used in the information processing system. The disclosure is not limited to this configuration. For example, the information processing system may be a printer performing a printing operation or an image forming apparatus other than the multi-function apparatus. For example, the information processing system is not limited to the image forming apparatus. The information processing system may be any apparatus that is capable of communication, for example, may be a terminal apparatus, such as a personal computer or a smart phone.

According to the exemplary embodiment, the CPU 21 transmits the execution instruction to the second multi-function apparatus 12 selected as the execution apparatus performing the proxy synchronization if the first multi-function apparatus 11 has shifted to the communication disabled state. The disclosure is not limited to this configuration. For example, if the first multi-function apparatus 11 shifts to the communication disabled state, the CPU 21 may transmit the execution instruction to a predetermined second multi-function apparatus 12.

According to the exemplary embodiment, the second multi-function apparatus 12 performing the proxy synchronization for another second multi-function apparatus 12 is selected as the execution apparatus. The disclosure is not limited to this configuration. For example, a second multi-function apparatus 12 that is communicable with the virtual device 13 and has the lowest synchronization load may be usually selected as the execution apparatus.

According to the exemplary embodiment, if a second multi-function apparatuses 12 performing the proxy synchronization is not present, a second multi-function apparatus 12 that is communicable with the virtual device 13 and has the lowest synchronization load is selected as the execution apparatus. The disclosure is not limited to this configuration. For example, the second multi-function apparatus 12 may be selected according to a predetermined priority order from the second multi-function apparatuses 12 communicable with the virtual device 13.

According to the exemplary embodiment, if the disability information indicating that the second multi-function apparatus 12 has performed the proxy synchronization has shifted to the communication disabled state is acquired, the CPU 21 transmits the execution instruction to another different second multi-function apparatus 12 different from the second multi-function apparatus 12 having performed the proxy synchronization. The disclosure is not limited to this configuration. If the disability information indicating that the second multi-function apparatus 12 having performed the proxy synchronization has shifted to the communication disabled state is acquired, the proxy synchronization may be thereafter performed no longer.

According to the exemplary embodiment, if the first multi-function apparatus 11 has shifted from the communication disabled state to the communication enabled state, the CPU 21 transmits, to the second multi-function apparatus 12, the end instruction causing the second multi-function apparatus 12 to end the proxy synchronization. The disclosure is not limited to this configuration. For example, even when the first multi-function apparatus 11 has shifted from the communication disabled state to the communication enabled state, the CPU 21 may cause the second multi-function apparatus 12 to continue the proxy synchronization.

According to the exemplary embodiment, the CPU 21 resumes the standard synchronization when the second multi-function apparatus 12 ends the proxy synchronization. The disclosure is not limited to this configuration. For example, the CPU 21 may resume the proxy synchronization before the second multi-function apparatus 12 ends the proxy synchronization.

In the exemplary embodiments above, the term “processor” refers to hardware in a broad sense. Examples of the processor include general processors (c.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

According to the exemplary embodiments, the information processing system includes multiple apparatuses but alternatively, includes only a single apparatus. According to the exemplary embodiments, the information processing system includes a single apparatus but alternatively the information processing system may include multiple apparatuses. In other words, the term “system” in the exemplary embodiments may include a single apparatus or multiple apparatuses.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system including:
a processor configured to:
   perform standard synchronization that synchronizes information between the information processing system and a synchronization destination by communicating with the synchronization destination at predetermined time intervals; and
   if the information processing system becomes unable to communicate with the synchronization destination in a communication disabled state, transmit, to one of the other information processing systems performing the standard synchronization, an execution instruction that causes the one information processing system to perform proxy synchronization to operate as a proxy for synchronization of the information between the information processing system and the synchronization destination.
      (((2)))

In the information processing system according to (((1))), the processor is configured to:
acquire, from the other information processing systems, selection information serving as selection criteria according to which an execution system caused to perform the proxy synchronization is selected from among the other information processing systems;
select the execution system from the other information processing systems in accordance with the selection information; and
transmit the execution instruction to the selected execution system. (((3)))

In the information processing system according to (((2))), the selection information is execution information indicating whether the one information processing systems performs the proxy synchronization for another different information processing system different from the information processing system, and
wherein the processor is configured to:
   in accordance with the execution information, select as the execution system the one information processing system that performs the proxy synchronization of the different information processing system; and
   transmit the execution instruction to the selected execution system.
      (((4)))

In the information processing system according to one of (((2))) and (((3))), the selection information is communication information indicating whether the one information processing system is communicable with the synchronization destination, and
wherein the processor is configured to:
   in accordance with the communication information, select as the execution system the one information processing system communicable with the synchronization destination; and
   transmit the execution instruction to the selected execution system.
      (((5)))

In the information processing system according to (((4))), the selection information includes the communication information indicating whether the one information processing system is communicable with the synchronization destination and includes load information indicating a synchronization load when the one information processing system is synchronized with information on the synchronization destination, and
wherein the processor is configured to:
   in accordance with the communication information and the load information, select as the execution system the one information processing system that is communicable with the synchronization destination and has a minimum synchronization load; and
   transmit the execution instruction to the selected execution system.
      (((6)))

In the information processing system according to one of (((1))) through (((5))), the processor is configured to, if information indicating a communication disabled state in which the one information processing system having performed the proxy synchronization becomes unable to communicate with the synchronization destination is acquired, transmit the execution instruction to the different information processing system different from the one information processing system.

(((7)))

In the information processing system according to (((6))), the processor is configured to:
acquire, from multiple different information processing systems, selection information serving as selection criteria according to which an information processing system serving as an execution system caused to perform the proxy synchronization is selected from among the different information processing systems;
select an information processing system as the execution system from the different information processing systems in accordance with the selection information; and
transmit the execution instruction to the selected execution system.
   (((8)))

In the information processing system according to one of (((1))) through (((7))), the processor is configured to, if the information processing system shifts from the communication disabled state to a communication enabled state in which the information processing system is communicable with the synchronization destination, transmits to the one information processing system an instruction to end execution of the proxy synchronization.

(((9)))

In the information processing system according to (((8))), the processor is configured to, if the one information processing system has ended the execution of the proxy synchronization, resume the standard synchronization.

(((10)))

An information synchronization system including:
a synchronization destination;
a first information processing system that performs standard synchronization that synchronizes information with the synchronization destination by communicating with the synchronization destination at predetermined time intervals; and
a second information processing system that performs the standard synchronization,
wherein if communication with the synchronization destination shifts to a communication disabled state, the first information processing system transmits, to the second information processing system, an execution instruction that causes the second information processing system to perform proxy synchronization to operate as a proxy for synchronization of the information between the first information processing system and the synchronization destination.
   (((11)))

A program causing a computer to execute a process for processing information, the process comprising:
performing standard synchronization that synchronizes information between the information processing system and a synchronization destination by communicating with the synchronization destination at predetermined time intervals; and
if the information processing system becomes unable to communicate with the synchronization destination in a communication disabled state, transmitting, to one of the other information processing systems performing the standard synchronization, an execution instruction that causes the one information processing system to perform proxy synchronization to operate as a proxy for synchronization of the information between the information processing system and the synchronization destination.

What is claimed is:

1. An information processing system comprising:
a processor configured to:
perform standard synchronization that synchronizes information between the information processing system and a synchronization destination by communicating with the synchronization destination at predetermined time intervals; and
if the information processing system becomes unable to communicate with the synchronization destination in a communication disabled state, transmit, to one of the other information processing systems performing the standard synchronization, an execution instruction that causes the one information processing system to perform proxy synchronization to operate as a proxy for synchronization of the information between the information processing system and the synchronization destination.

2. The information processing system according to claim 1, wherein the processor is configured to:
acquire, from the other information processing systems, selection information serving as selection criteria according to which an execution system caused to perform the proxy synchronization is selected from among the other information processing systems;
select the execution system from the other information processing systems in accordance with the selection information; and
transmit the execution instruction to the selected execution system.

3. The information processing system according to claim 2, wherein the selection information is execution information indicating whether the one information processing system performs the proxy synchronization for another different information processing system different from the information processing system, and
wherein the processor is configured to:
in accordance with the execution information, select as the execution system the one information processing system that performs the proxy synchronization for the different information processing system; and
transmit the execution instruction to the selected execution system.

4. The information processing system according to claim 2, wherein the selection information is communication information indicating whether the one information processing system is communicable with the synchronization destination, and
wherein the processor is configured to:
in accordance with the communication information, select as the execution system the one information processing system communicable with the synchronization destination; and
transmit the execution instruction to the selected execution system.

5. The information processing system according to claim 4, wherein the selection information includes the communication information indicating whether the one information processing system is communicable with the synchronization destination and includes load information indicating a synchronization load when the one information processing system is synchronized with information on the synchronization destination, and
wherein the processor is configured to:
in accordance with the communication information and the load information, select as the execution system the one information processing system that is communicable with the synchronization destination and has a minimum synchronization load; and
transmit the execution instruction to the selected execution system.

6. The information processing system according to claim 1, wherein the processor is configured to, if information indicating a communication disabled state in which the one information processing system having performed the proxy synchronization becomes unable to communicate with the synchronization destination is acquired, transmit the execution instruction to the different information processing system different from the one information processing system.

7. The information processing system according to claim 6, wherein the processor is configured to:
acquire, from a plurality of the different information processing systems, selection information serving as selection criteria according to which an information processing system serving as an execution system caused to perform the proxy synchronization is selected from among the different information processing systems;
select an information processing system as the execution system from the different information processing systems in accordance with the selection information; and
transmit the execution instruction to the selected execution system.

8. The information processing system according to claim 1, wherein the processor is configured to, if the information processing system shifts from the communication disabled state to a communication enabled state in which the information processing system is communicable with the synchronization destination, transmits to the one information processing system an instruction to end execution of the proxy synchronization.

9. The information processing system according to claim 8, wherein the processor is configured to, if the one information processing system has ended the execution of the proxy synchronization, resume the standard synchronization.

10. An information synchronization system comprising:
a synchronization destination;
a first information processing system that performs standard synchronization that synchronizes information with the synchronization destination by communicating with the synchronization destination at predetermined time intervals; and
a second information processing system that performs the standard synchronization,
wherein if communication with the synchronization destination shifts to a communication disabled state, the first information processing system transmits, to the second information processing system, an execution instruction that causes the second information processing system to perform proxy synchronization to operate as a proxy for synchronization of the information between the first information processing system and the synchronization destination.

11. A non-transitory computer readable medium storing a program causing a computer to execute a process for processing information, the process comprising:
performing standard synchronization that synchronizes information between the information processing system and a synchronization destination by communicating with the synchronization destination at predetermined time intervals; and
if the information processing system becomes unable to communicate with the synchronization destination in a communication disabled state, transmitting, to one of the other information processing systems performing the standard synchronization, an execution instruction that causes the one information processing system to perform proxy synchronization to operate as a proxy for synchronization of the information between the information processing system and the synchronization destination.
